(19) United States
(12) Patent Application Publication
(10) Pub. No.: US 2005/0175340 A1
(43) Pub. Date: Aug. 11, 2005

(54) Optical transmission network management process

(75) Inventors: Denis Penninckx, Nozay (FR); Olivier Audouin, Les Moulineaux (FR); Pierre Peloso, Villebon Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/017,934

(22) Filed: Dec. 22, 2004

(30) Foreign Application Priority Data
Dec. 23, 2003 (FR) 03 15 223

(51) Int. Cl. H04B 10/08

(52) U.S. Cl. 398/27; 398/7

(57) ABSTRACT

The routes for transmitting optical signals between the nodes (N1-N6) of a transparent network are selected according to the estimated error rate (ERe) values presented by the signals received after being transmitted along these routes. To limit the number of measurements to be made before the network is commissioned, a function (G) relating to the parameters characteristic of the network's optical links is used. This function is an interpolation function providing, for each set (QoT) of parameters associated with a given route, a corresponding estimated error rate (ERe) value. To evaluate the accuracy of the interpolation, during the network's operation, error rate measurements are performed, relating to signals effectively transmitted along given routes, and these measurements serve either to readjust the margin of uncertainty to be applied to exploit the estimated error rates (ERe), or to modify the function (G) to improve its interpolation accuracy.

The invention is in the field of optical transmission networks, and more specifically, “transparent” networks using wavelength multiplexing. It concerns a management process for such a network that allows the optimization of the optical signal routings.

Let us remember that optical networks mainly consist of nodes connected together via optical links. A node is often connected to several other nodes and therefore incorporates routing functions to selectively route signals received from upstream links towards other downstream links according to the respective destinations of the signals.

In networks implementing wavelength multiplexing, usually known as WDM (“Wavelength Division Multiplexing”), the signals carried in the links are multiplex signals consisting of several components carried by different optical frequencies respectively.

In WDM networks, the nodes may be equipped with regeneration devices acting separately on each channel of the WDM multiplexes received to carry out reformatting. The network, which is described as “opaque”, presents the advantage of being able to ensure a minimum transmission quality set for all the routes likely to be followed by the various channels. However, the presence of the regenerators affects the cost of the network, in proportion to the number of WDM channels.

Another less costly solution is to design a network without individual channel regeneration devices. Such a network, which is described as “transparent”, may, however, include optical amplifiers arranged to simultaneously amplify the channels used by the WDM multiplexes transmitted. A possible compromise is also to create a “hybrid” network in which only certain nodes or links are equipped with regenerators, or in which nodes are equipped with a number of regenerators, which are only used selectively in case of need.

The invention may apply to transparent networks or to the transparent parts of the hybrid networks defined above. Thus, in a transparent network (or in the transparent part of a hybrid network), the links between nodes, which are direct or indirect through the intermediary of other nodes, are themselves transparent.

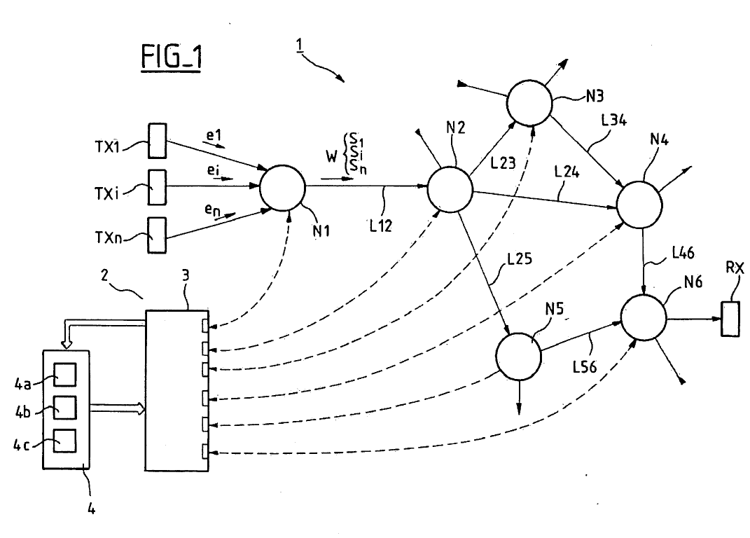

To illustrate the context of the invention, FIG. 1 shows part of a transparent network 1 of the traditional type that comprises a plurality of N1 to N6 nodes and optical links between neighboring nodes L12, L23, . . . , L56. A link may comprise a single optical fiber slice or several slices coupled by means of optical amplifiers.

According to the example shown, the node N1 is an access node to the network that communicates with transmitting terminals TX1, . . . , TXi, . . . , TXn. The node N6 is also an access node that communicates with receiving terminals such as RXs.

The network core nodes N2 to N5 are equipped with spectral and spatial optical switches able to selectively route signals received from upstream nodes towards downstream nodes. For example, the node N2, which receives a W multiplex from the node N1, may couple each of its spectral components (wavelengths or wavelength bands) S1, Si and Sn selectively towards one of the links L23, L24 and L25 in the direction of the nodes N3, N4 and N5 respectively.

In the example shown, the network is managed centrally by a network controller 2. The controller 2 mainly consists of a processing unit 3 cooperating with a memory 4. The unit 3 may communicate with the nodes by means of control links, symbolized by arrowed broken lines. These links allow the controller 2 to constantly receive, from the access nodes, all the signal transmission requests within the network and to consequently control the node switches in order to force each of these signals, once transmitted, to follow a route selected according to data relating to the network's topology and to all the requests. These data are brought together in the form of a routing table 4a contained in the memory 4.

For example, if the signals e1 and ei transmitted from the transmitting terminals TX1, TXi and TXn need to be transmitted to respective receiving terminals such as RXs, the access node N1 must convert them into optical signals S1, Si and Sn and create a W multiplex incorporating them. Beforehand, the node N1 transmits to the controller 2 a request that contains information relating to the signals, and in particular their respective destinations. According to this request, and taking into account any other requests from other access nodes, the controller 2 controls the node switches through which the W multiplex S1, Si and Sn optical signals in particular must pass, in order to create uninterrupted optical links between the node N1 and the access nodes to the respective receiving terminals. In this example, we can see that several routes are possible for accessing the RX receiving terminal: N1-N2-N3-N4-N6, or N1-N2-N4-N6, or N1-N2-N5-N6.

Usually, each signal to be transmitted must have a predefined minimum transmission quality, this quality being measured in practice through a maximum error rate that the signal received after transmission is permitted to present. This required level of quality is not necessarily the same for all signals as there are often different service quality classes attributable to signals, these classes imposing different maximum permissible error rate values associated with the signals received.

However, in transparent networks, the degradation experienced by a signal during its transmission depends first of all on the route that it has followed. Therefore, to effectively control the routing within such a network, in other words to determine the appropriate routes for transmitting any signal between two transmitting and receiving nodes, it is important to determine the foreseeable error rate in advance (or a quantity representative of the error rate) for each possible route within the network.

To achieve this, systematic tests could be carried out to measure the error rates associated with all the possible routes before the network's operation. However, this solution is only feasible for relatively small networks. In addition, as the transmission quality of a signal is also dependent on its carrier wavelength, the tests must be performed for several wavelengths. This means that, for example, for a continental-sized network consisting of several tens of nodes using several tens of wavelengths, the number of measurements may be as many as several tens of thousands. For example, a transparent network consisting of 30 nodes with 100 direct links between nodes and designed for 100 wavelengths would require around 1 million measurements. Such a large number of tests is costly and also delays the commissioning of the network.

Another, more economical, method is to estimate the error rate values indirectly through a more limited number of measurements prior to operation. This method is based on the following considerations.

The error rate observable for a signal of a given wavelength after transmission by a data link depends on a number of parameters characteristic of this link and this wavelength. These parameters are “cumulative”, in other words for each of them there is a composition law allowing the value to be calculated for a link compromising two cascaded slices, based on the values of this same parameter for the two slices. Thus, by establishing a function that provides the error rate based on these parameters, and knowing the values of these parameters for any link between neighboring network nodes, it is possible to determine the error rate value for any network route.

An analysis dealing with this subject is presented in the article entitled “New Physical Analysis of 10-GB/s Transparent Optical Networks”, D. Penninckx et al, IEEE Photonics Technology Letters, Vol. 15, N°5, 5 May 2003, pages 778 to 780.

The relevant parameters to be used to apply this method are therefore:
The OSNR, which stands for “Optical Signal-to-Noise ratio”,
The PMD, which stands for “Polarization Mode Dispersion”,
The GVD, which stands for “Group Velocity Dispersion”,
The φNL non-linear phase.

These parameters take the characteristic values of a given optical link, for a given wavelength. They may be viewed as the components of a four-dimensional vector known as a “transmission quality vector” or QoT.

The composition laws applicable to these parameters may be described as follows.

A first link is referred to as LiJ, for example the link between two neighboring nodes Ni and Nj, a second link adjacent to the first is referred to as Ljk, for example the link between two neighboring nodes Nj and Nk, and the link consisting of the cascaded first and second links is referred to as Lijk.

If we take Px, with x=1, 2, 3 or 4 respectively, to represent the parameters OSNR, PMD, GVD and φNL and we take Pxij, Pxjk and Pxijk to represent, respectively, the corresponding values of these parameters for the links Lij, Ljk, and Lijk, we arrive at:
1/P1ijk=1/P1ij+1/P1jk
(P2ijk)²=(P2ij)²+(P2jk)²
P3ijk=P3ij+P3jk
P4ijk=P4ij+P4jk

If we introduce a function H summarising these four ratios, with QoT=(P1, P2, P3, P4), we may state that:
QoTijk=H(QoTij, QoTjk)

Before the network's operation, the Pxij values are in this way determined for all the Lij links between two neighboring Ni and Nj nodes and for various wavelengths distributed across the WDM spectrum provided for. These values may be measured directly on site, or in the laboratory, through links with the same characteristics. The values of certain parameters, such as the GVD, may even simply be calculated according to these known characteristics.

Furthermore, series of error rate values (or of a quantity representative of the error rate) for various links of this type are measured experimentally. Using these error rate measurements and knowing the corresponding QoT vector values for these links, we can then find a QoT vector interpolation function G that may then provide an estimated error rate value for any other QoT vector value. This function may be an analytic function, typically an interpolation polynomial of an appropriate degree, for example a second or third degree polynomial. The function may also be in the form of a data table addressable according to the components of the QoT vector, in other words through the Px parameters. In this last case, the function used is a staged function.

We therefore arrive at:
ERe=G(QoT)

Note that the ERe quantity simply referred to here as the “error rate” may in fact be any quantity representative of the actual error rate, such as the Q factor often used in this context, or the error rate logarithm. Thus, the function G will in fact depend on the quantity used to express the error rate.

On the network's operation, to estimate the foreseeable error rate for a given route, the function H above is first applied to calculate the resultant of the QoT vector for the route according to the known values of this vector for the various links between neighboring nodes that make up the route. Next, the function G is applied to the QoT vector previously calculated to obtain the estimated error rate ERe.

If the maximum permissible error rate ER(S) is known for each signal S to be transmitted, by comparing the ER(S) value to the estimated error rate ERe for each possible route and for each possible carrier wavelength, the suitable and unsuitable route and wavelength couples may be determined.

If there are no suitable route and carrier wavelength couples, this means that the service quality may not, in any case, be complied with, and that regeneration devices must be installed or activated.

In view of the approximate nature of the method, in order to decide whether a route is suitable, a margin will be applied in practice that ensures that the maximum permissible error rate value ER(S) is sufficiently greater than the estimated error rate. ERe. This margin may be characterized by a minimum permissible positive value M for the difference Δ=ER(S)−ERe. The margin may also be characterized by a minimum value greater than 1 for the ER(S)/ERe ratio, but this second case is in fact the same as the first if the logarithmic values of the quantities are taken.

The method presented above allows a maximum reduction of the number of test operations, but its disadvantage is its lack of accuracy, which leads to the overdimensioning of the margin value to be adopted to ensure that the service qualities are complied with. The result is that the network's resources are not used in an optimum way.

To improve the way in which the resources of a transparent or partially transparent network are used, we need to know as precisely as possible and/or improve the accuracy of the interpolation presented by said function (G).

The invention is therefore aimed at improving knowledge of this accuracy without the need for lengthy test procedures prior to the network's commissioning.

The method proposed is designed to allow scalable management of the network, while gradually improving the accuracy of error rate knowledge over time and without disrupting the network's operation.

More specifically, the invention is aimed at establishing an at least partially transparent optical network management process, the network comprising a plurality of nodes connected by means of optical links, the selecting of routes for the transmission of optical signals between two network nodes taking into account the estimated error rate values respectively presented by the optical signals received after being transmitted along possible routes connecting these nodes, this process using a function of the parameters characteristic of said network optical links, this function being an interpolation function able to provide, for each set of parameters associated with a given route, an estimated error rate value, characterized by the fact that the accuracy of the interpolation presented by said function is evaluated by performing, during the network's operation, error rate measurements relating to the signals transmitted along data routes and by comparing each measured error rate value with the corresponding estimated error rate value by means of said function.

The results of these comparisons may be exploited in several ways. According to a first possibility, the selecting of routes takes into account the comparisons between said estimated error rate values and the maximum permissible error rate values for the signals received, with a route being selected to transmit a given signal if a variance value representative of the difference between its maximum permissible error rate value and the foreseeable error rate value for the route in question exceeds a predetermined margin value. Said predetermined margin value will then be respectively increased or decreased according to whether said measured error rate value is greater than or equal to said corresponding estimated error rate value.

Advantageously, if said variance value exceeds said predetermined margin value for several routes, the one for which said variance value is the lowest will be selected. This arrangement contributes to optimizing the use of the network's resources.

According to another possibility, which advantageously complements the previous option, according to comparisons between said measured and estimated error rate values, said function is modified to improve its interpolation accuracy.

The function should preferably only be modified if the measurements performed are sufficiently significant statistically, in other words if several series of error rate measurements relating to signals transmitted along the same given route are performed.

In practice, according to another aspect of the invention, during normal network operation and during periods for which certain routes are not in use, error rate measurements are performed during these out-of-use periods and for these out-of-use routes.

These measurements are facilitated, however, if the network implements transmission systems incorporating error detection devices. In this case, the error rate measurements may be performed by using these error detection systems during normal network operation, independently of any conditions relating to the use of the routes involved.

Other aspects and benefits of the invention will appear in the remainder of the description given in relation to the figures.

FIG. 1 diagrammatically represents a transparent network example according to the invention.

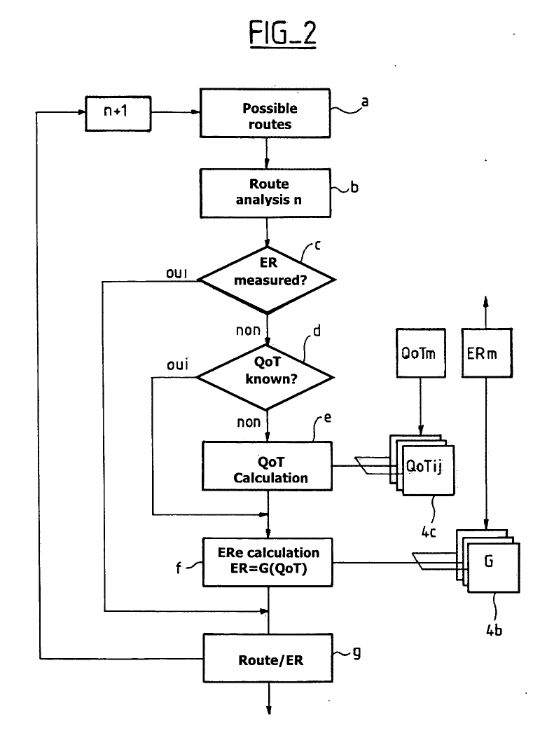

FIG. 2 is a flow chart showing the main steps involved in the process according to the invention.

The implementation of the process according to the invention will now be explained first of all with the help of FIGS. 1 and 2.

The practical implementation of the process according to the invention in a network such as that shown in FIG. 1 will take place by means of an appropriate program executable by the processing unit 3 of the network controller 2. This program implements the functions G and H, in particular using the tables 4b and 4c.

The main steps in a program algorithm example are shown in FIG. 2, in the form of a flow chart. It is assumed that a signal is to be transmitted from a transmitting node towards a receiving node and that several possible routes are identified in step a. One of these routes to be analyzed is selected in step b.

The following step c checks whether the route analyzed has previously undergone an error rate measurement recorded by the processing unit 3. If such is the case, the process moves to step g, which associates the route with the errors rates measured for various carrier wavelengths. Otherwise, the process moves to step d, which checks whether the parameters making up the QoT vector have already been evaluated for this route. If so, the process moves to step f, otherwise the parameters are first of all calculated in step e, by means of the function H and QoTij parameter values evaluated and recorded beforehand in table 4c for the Lij links making up the route.

The following step f consists of determining the estimated error rate ERe values, using the function G, for various carrier wavelengths. Step g then associates the route analyzed with these estimated values for the various wavelengths.

The same process is repeated as described above for the other possible routes. All these estimated error rate values for the various possible routes and wavelengths are then used to select the appropriate route.

According to the invention, error rate measurements relating to signals transmitted according to various routes are performed during network operation.

Usually, such a network implements transmission systems equipped with error detection and error correction devices. In this case, the error rate measurement devices advantageously use these error detection systems during normal network operation. In the absence of error detection devices, advantage may be taken of periods when the routes are not in use to perform measurements.

The new error rate ERm values thus measured and the corresponding routes are then recorded. For each new route that undergoes measuring, the value measured is compared with the corresponding estimated error rate by means of the function G.

According to this comparison, one or the other of the following operations may be performed:

a) The margin value may be respectively increased or decreased according to whether the measured error rate ERm value is greater than or equal to the corresponding estimated error rate ERe value, or

b) The function G may be modified to improve its interpolation accuracy.

The function should preferably only be modified if the measurements performed are sufficiently significant statistically, in other words if several series of error rate measurements relating to signals transmitted along the same given route are performed. If the function G is in the form of a table, this modification is reduced to completing this table with new corresponding address and data values.

Furthermore, the parameters characteristic of the links are evaluated before normal network operation, at least for each link connecting two neighboring network links. However, the invention may also provide for certain of these parameters being calculated for other links based on these parameters' values, or being evaluated during network operation. During normal network operation, there are often periods when certain routes are not being used for transmissions. It is advantageous to perform corresponding measurements during these out-of-use periods to evaluate the parameters of these out-of-use routes.

In the latter cases, the new QoTm values of the QoT vector are added to table 4c, as shown in diagrammatic form in FIG. 2.

Of course, the algorithm presented above may have many variants.

1. An at least partially transparent optical network management process, the network comprising a plurality of nodes (N1-N6) connected by means of optical links, the selecting of routes for the transmission of optical signals between two network nodes taking into account the estimated error rate values (ERe) respectively presented by the optical signals received after being transmitted along possible routes connecting these nodes, this process using a function (G) of the parameters characteristic of said network optical links, this function being an interpolation function able to provide, for each set of parameters associated with a given route, a corresponding estimated error rate value (ERe), characterized by the fact that the accuracy of the interpolation presented by said function (G) is evaluated by performing, during the network's operation, error rate measurements relating to the signals transmitted along given routes and by comparing each measured error rate value (ERm) with the corresponding estimated error rate value (ERe), estimated by means of said function (G).

2. A process according to claim 1, characterized by the fact that said selecting of routes takes into account comparisons between said estimated error rate values (ERe) and maximum permissible error rate values (ER(S)) for the signals received, with the possibility of a route being selected to transmit a given signal if a variance value representative of the difference between its maximum permissible error rate value and the foreseeable error rate value (ERe) for the route in question exceeds a predetermined margin value, and by the fact that said predetermined margin value is respectively increased or decreased according to whether said measured error rate value (ERm) is greater or less than said corresponding estimated error rate value (ERe).

3. A process according to claim 2, characterized by the fact that if said variance value exceeds said predetermined margin value for several routes, the one for which said minimum variance value is the lowest will be selected.

4. A process according to claim 1, characterized by the fact that according to the comparisons between said measured (ERm) and estimated (ERe) error rate values, said function (G) is modified to improve its interpolation accuracy.

5. A process according to claim 4, characterized by the fact that said function (G) is only modified if several series of error rate measurements relating to signals transmitted along the same given route are performed.

6. A process, according to claim 1, characterized by the fact that during normal network operation and during periods for which certain routes are not in use, error rate measurements are performed during these out-of-use periods and for these out-of-use routes.

7. A process according to claim 1, characterized by the fact that if said network implements transmission systems equipped with error detection devices, the error rate measurements use these error detection systems during normal network operation.

8. A process according to claim 1, characterized by the fact that said parameters characteristic of said optical links are evaluated before normal network operation, at least for each link connecting two neighboring network nodes, while for other links, some of these parameters are calculated based on the values of the parameters that have already been evaluated or else are evaluated during said operation.

9. A process according to claim 8, characterized by the fact that during normal network operation and during periods for which certain routes are not in use, error rate measurements are performed during these out-of-use periods and for these out-of-use routes.
